(19) United States
(12) Patent Application Publication
(10) Pub. No.: US 2006/0259767 A1
(43) Pub. Date: Nov. 16, 2006

(54) Methods and apparatuses for information authentication and user interface feedback

(76) Inventors: Robert Paul Mansz, Rothesay (CA); Ryan Groom, Hanwell (CA); Phong Van Ha, Fredericton (CA)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/130,665

(22) Filed: May 16, 2005

(51) Int. Cl. H04L 9/00

(52) U.S. Cl. 713/168

(57) ABSTRACT

Methods and apparatuses for management of entitlement to security operations. In one aspect, a method for authentication, includes: determining an indication of a cursor being positioned over a graphical user interface element of a first application process for a period of time, where the first application process is to present information and the graphical user interface element has encrypted data obtained with the information; and in response to the indication: obtaining the encrypted data from the graphical user interface element; and determining whether or not the information is trusted using the encrypted data. In another aspect, a method for authentication, includes: determining whether or not information loaded into a first application for display to a first user is trusted based on encrypted data obtained with the information; and in response to a determination that the information is trusted, presenting at least one of a user designated visual cue and a user designated audio cue to indicate that the information is trusted.

### TECHNOLOGY FIELD

At least some embodiments of the present invention relate to digital security, and more particularly to information authentication and providing feedback to users.

### BACKGROUND

Verifying valid web sites and electronic messages (e.g., email messages) has become very difficult for computer users. Security guidance dictates that users should not open email attachments or even click on web links contained in email messages.

Businesses, governments, consumer advocacy organizations and individuals continue to have interest in determining the degree to which an online site can be trusted. Whether learned from an advertisement or embedded as a link in an email, unwary consumers who follow these links can unwittingly find themselves in the grasp of an identity-theft scheme. The process of “Phishing”, or the unauthorized collection of personally identifying information, causes consumers to be tricked into disclosing their banking credentials, government identification, or other information that would normally be private.

Aside from heightened diligence on the part of the consumer, a traditional approach is the application of an online trust mark. For example, an online mark, sometimes characterized as a seal, is included as a part of the web page to indicate that the site operator has agreed to be bound by a code of practice. The mark is an advisory, rather than a guarantee of performance, since the binding is often weak and certification problematic. The traditional online trust marks have been criticized for a number of reasons, as listed below.

For example, counterfeit or fraudulent use of a trust mark, especially in the case of relatively transient phishing sites, undermines any intrinsic value of the trust mark.

For example, the processes through which marks are acquired are often based on self-assessment schemes. Critics argue that self-assessment is inherently open to abuse by the unscrupulous or merely incompetent.

For example, the poor performance of certifying bodies, including prominent seal issuers, such as TRUSTe, who are characterized by critics as slow to respond to consumer concerns about abuses or who lack the resources to monitor compliance with their rules and ensure that the trust mark is removed from a site that breaches those rules.

For example, there exists skepticism that a conflict of interest may exist, or doubt that a business model exists when significant investment is required for building an international brand and then maintaining it through ongoing promotion, compliance checks and litigation against entities that abuse the particular mark.

For example, the plethora of competing trust mark bodies, ranging from those restricted to a particular jurisdiction to those with global ambitions, confuses consumers who access sites from markets that each have their own trust mark regime.

Cryptography has been used to secure the information transmitted over unsecured media, such as Internet. In symmetric key cryptography, the same key is used to both encrypt and decrypt the content. In public/private key cryptography, different but related keys are used to encrypt and decrypt the content.

In public key cryptography, a pair of two complementary keys, a public key and a private key, are such that any information digitally signed using the private key can only be verified using the public key, and conversely, any information encrypted using the public key can only be decrypted using the private key.

Typically, a trusted party called a certificate authority issues a digital certificate. The certificate confirms the authenticity of an identity with a digital signature of the certificate authority. The digital signature of the certificate is generated using the private key of the certificate authority. The certificate authority's public key can be used to verify the authenticity of the certificate.

The information encrypted using the public key of the identity can only be decrypted using the private key of the identity. The private key associated with the identity is the secret information, which when compromised allows others in possession of the private key to decrypt the information intended for the identity.

On the other hand, the private key of the identity can be used to sign information sent from the identity. The public key associated with the identity can be used to verify that the digitally signed information is from one in possession of the private key of the identity.

A typical digital certificate includes data representing the identity of the certificate holder (e.g., name, email address of the certificate holder), dates of validity of the certificate, and a public key that can be used to verify the digital signature of the holder. The digital certificate is typically issued by a trusted entity; and a public key of the trusted entity can be used to verify the digital signature of the digital certificate.

A traditional way to secure email messages involves the encryption of the message using the public key of the recipient and the digitally signing the message using the private key of the sender. Thus, using the public key of the sender, the recipient can verify that the message is from the one who is in possession of the private key of the sender; and only the one who is in possession of the private key of the recipient can decrypt the email message.

### SUMMARY OF THE DESCRIPTION

Methods and apparatuses for management of entitlement to security operations are described here. Some of the embodiments of the present invention are summarized in this section.

In one aspect of an embodiment of the present invention, a method for authentication, includes: determining an indication of a cursor being positioned over a graphical user interface element of a first application process for a period of time, where the first application process is to present information and the graphical user interface element has encrypted data obtained with the information; and in response to the indication: obtaining the encrypted data from the graphical user interface element; and determining whether or not the information is trusted using the encrypted data

In one example of an embodiment, the information comprises one of: a web page; and an email message. The first application process comprises a web browser; and the graphical user interface element comprises one of: a graphical representation of a trust mark; and a hyper link.

In one example of an embodiment, determining whether or not the information is trusted includes: verifying an identity of a sender of the information; verifying integrity of the information; and verifying an identity of a recipient of the information.

In one example of an embodiment, verifying the identity of the recipient includes decrypting the encrypted data using a private key of the recipient; verifying the identity of the sender includes decrypting a version of the encrypted data using a public key of the sender; and verifying the integrity of the information includes comparing a decrypted version of the encrypted data with a processed version of the information. In one example, the processed version of the information includes a digest of the information. In one example, the digest of the information contains unique challenge information negotiated between the sender and the recipient (or agents acting on their behalf) that prevents duplication or re-playing of the message. In one example, the digest of the information contains an indication of the recipient's rights (e.g. digital rights) related to the marked information.

In one example of an embodiment, the method further includes one of: presenting a personalized visual cue when the information is determined to be trusted; and presenting a personalized audio cue when the information is determined to be trusted.

In one example of an embodiment, the indication is determined through analyzing windows system messages. The visual cue and the audio cue are presented in a second process which is separate from the first application process. In one example, the second process is a background service process. In one example, the encrypted data is obtained from the graphical user interface element through a document object model (DOM). In one example, the second process presents the visual cue in a popup window near an icon tray of a desktop of a graphical user interface system.

In one example, at least one of the visual cue and the audio cue is specifically personalized for at least one of: a user of the first application process; and a sender of information.

In one example, at least one of the visual cue and the audio cue is selected from one or more lists for a user of the first application process. In one example, at least one of the visual cue and the audio cue is imported from user provided data.

In one example, the encrypted data includes a superencrypted version of a digital signature of a sender of the information on the information; and the digital signature is superencrypted with a public key of a recipient of the information.

In another aspect of an embodiment of the present invention, a method for authentication, includes: determining whether or not information loaded into a first application for display to a first user is trusted based on encrypted data obtained with the information; and in response to a determination that the information is trusted, presenting at least one of a user designated visual cue and a user designated audio cue to indicate that the information is trusted.

In one example of an embodiment, the visual cue is presented as part of the information in the first application; and the first application includes a web browser.

In one example of an embodiment, at least one of the visual cue and the audio cue is selected by the first user from one or more lists.

In one example of an embodiment, determining whether or not the information is trusted includes verifying an identity of a sender of the information; at least one of the visual cue and the audio cue is user selected specifically for the sender. In one example of an embodiment, at least one of the visual cue and the audio cue is customized by the first user.

In one example of an embodiment, the method further includes: detecting presence of the encrypted data in the information loaded into the first application process in a second process through a document object model (DOM); and detecting an event of a cursor over a representation of the encrypted data in the first application through analyzing windows system messages in the second process.

The present invention includes methods and apparatuses which perform these methods, including data processing systems which perform these methods, and computer readable media which when executed on data processing systems cause the systems to perform these methods.

Other features of the present invention will be apparent from the accompanying drawings and from the detailed description which follows.

### BRIEF DESCRIPTION OF THE DRAWINGS

The present invention is illustrated by way of example and not limitation in the figures of the accompanying drawings in which like references indicate similar elements.

FIG. 1 shows an example of a communication system according to one embodiment of the present invention.

FIG. 2 shows an example of a display of a web page to invite a user to register according to one embodiment of the present invention.

FIG. 3 shows an example of options for a user to personalize visual/audio cue as security feedback according to one embodiment of the present invention.

FIG. 4 shows an example of displaying a web page with personalized visual/audio feedback according to one embodiment of the present invention.

FIG. 5 shows another example of displaying a web page with personalized visual/audio feedback according to one embodiment of the present invention.

FIGS. 6 and 7 show flow diagrams of methods to provide personalized visual/audio feedback according to embodiments of the present invention.

FIG. 8 shows a block diagram example of a data processing system which may be used with the present invention.

### DETAILED DESCRIPTION

The following description and drawings are illustrative of the invention and are not to be construed as limiting the invention. Numerous specific details are described to provide a thorough understanding of the present invention. However, in certain instances, well known or conventional details are not described in order to avoid obscuring the description of the present invention. References to one or an embodiment in the present disclosure are not necessarily references to the same embodiment; and, such references mean at least one.

One embodiment of the present invention involves a method and system to provide proof of membership within a trust network, which (for example) can be used to combat phishing. One embodiment of the present invention provides an automated method for the validation of trust mark and personalized audio and/or visual cue as feedback to indicate the result of the validation of the trust mark.

According to one embodiment of the present invention, a new type of value-add-service transcends the commoditized nature of communication today, and allows services built upon—and dependent upon—specialized security to be charged on a per-use or pre-paid fashion. One embodiment of the invention supports both subscription-based or instant-pay (“pay-as-you-go”) rating and metering models.

In one embodiment of the present invention, personalized visual cue and/or audio cue is presented to the user when the authenticity of the information (e.g., a web page or an email message) is verified. In one embodiment, the verification is performed with respect to the identity of the sender, and/or the identity of the recipient, and/or the integrity of the information. The personalized visual/audio cue provides a secure and friendly interface to convey the security status of the information to the user.

In one embodiment of the present invention, a web site (e.g., an online banking site) registers with a security server. After the registration, the web site obtains a web control (e.g., ActiveX, Java or Flash, servlet, etc.), which can be used in emails for direct marketing promotions and for notification of significant account events (e.g. overdraft), and/or in the web pages of the site to demonstrate the trustable nature of the site vs. spoofed or pharmed sites.

In one embodiment, the control has a unique public/private key pair associated with it. The control is able to sign and encrypt a random, salted, challenge. The web site installs the control on the personal banking pages and/or the program for sending emails.

In one embodiment, the pages with the control are within an authenticated context, so that the identity of a surfer and Twinkle user can be related to the own internal records of the web site (e.g., bank). In one embodiment, a trust mark according to one embodiment of the present invention is also embedded in the web page outside the authenticated context (e.g., a login page) so that the web users can easily tell the trustable nature of the web page vs. spoofed or pharmed sites. Such trust marks can be used to combat phishing.

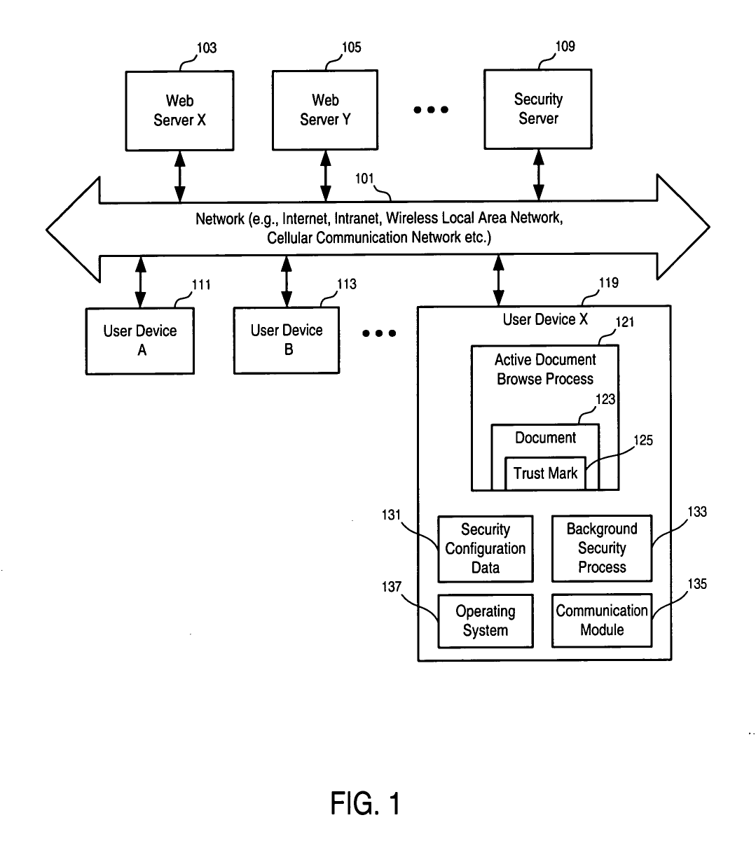

FIG. 1 shows an example of a communication system according to one embodiment of the present invention.

In FIG. 1, users devices (e.g., 111, 113, . . . , 119) can communicate with each other and with the web servers (e.g., 103, 105, . . . ) and the security server (109) through the network (101). The network (101) may include Internet, intranet, wireless local area network, cellular communication network, etc.

For example, the user device (119) may obtain a document (e.g., a web page or an email message) from another user device (e.g., 111) or from a web server (e.g., 103). The user device (119) includes an operating system (137) and a communication module (135) which support the operations of the active document browser process (121) and the background security process (133).

In one embodiment of the present invention, the document (123) can have a trust mark (125). When the document is loaded into the active document browser process (121) on the user device (119), the trust mark (125) is detectable by the background security process (133) running on the user device (119).

In one embodiment of the present invention, the background security process (133) is different and separate from the active document browser process (121) on the user device (119).

In one embodiment of the present invention, the background security process (133) verifies the authenticity of the document (123) using the trust mark (125), based on the security configuration data (131) on the user device (119).

In one embodiment of the present invention, the background security process (133) accesses the trust mark (125) in the active document browser process through a document object model (DOM). For example, the active document browser may be a DOM enabled web browser, such as Internet Explorer or Mozilla Firefox. Alternatively, the document browser process (121) may be custom made to have the capability to communicate with the background security process (133) (e.g., through a plug-in module or built-in module).

In one embodiment of the present invention, the background security process determines whether or not the document is from a sender that is trusted by the user device (119), according to the configuration data (131). If the background security process determines that the document can be trusted, visual and/or audio cue is presented on the user device (119) as a feedback to the user. In one embodiment of the present invention, the visual and/or audio cue is personalized.

In one embodiment of the present invention, the trust mark includes data that is encrypted using the public key of the security server (109). The data includes identity information of the sender (e.g., a web site). The background security process (133) communicates the trust mark to the security server (109) to verify the identity of the sender and integrity of the document.

For example, when the user device (119) downloads a web page from a web server (e.g., 103) without revealing its identity, the web server may encrypt the trust mark data using the public key of the security server (109). The background security process (133) provides the encrypted trust mark data to the security server (109) for verification. In one embodiment of the present invention, the encrypted data includes a digital signature of the sender on the document. The digital signature includes a digest of the document encrypted using the private key of the sender. To verify the integrity of the document, the background security process computes the digest according to the received document and sends the computed digest and the encrypted data to the security server for verification.

Alternatively, the trust mark data is not encrypted with the public key of the security server. The background process obtains the public key of the sender from the security server to verify the digital signature of the sender.

In one embodiment of the present invention, the trust mark also includes identity information of the recipient so that the security server (or the user device) can verify that the document is to be received at the user device (119).

In one embodiment of the present invention, the trust mark includes data that is encrypted using the public key of the user device (119). The data includes identity information of the sender (e.g., a web site). The background security process (133) may verify the identity of the sender and integrity of the document with or without the help of the security server (109). For example, the user device (119) may store a copy of the public key of the sender as a part of the security configuration data (131) or retrieve the public key of the sender according to the identity of the sender from the security server. Alternatively, the background security process (133) may decrypt the trust mark data using the private key of the user device (119) and transmit the trust mark data to the security server (109) for verification.

For example, when the sender of the document knows the identity of the user device (119), the sender may encrypt the trust mark data using the public key of the user device (109). Thus, the background security process (133) can use its private key to verify that the information is intended for the user device (109).

In one embodiment, the sender may first encrypt the trust mark data using the public key of the security server and then superencrypt the data using the public key of the user device (119). After the verification of the destination of the document, the background security process then sends the trust mark data as encrypted using the public key of the security server for sender verification. Alternatively, the sender may not encrypt the trust mark data using the public key of the security server.

In one embodiment of the present invention, the security server (109) performs at least a portion of the cryptographic operations for the verification of the trust mark for the background security process (133).

In one embodiment of the present invention, once the trust mark is verified, the background security process (133) communicates with the active document browser process (121) to display a personalized graphical representation of the trust mark in the document or on the graphical user interface desktop. Since the displayed personalized graphical representation of the trust mark is not received from the sender (e.g., a web site), the chance of counterfeit or fraudulent use of the graphical representation the trust mark is reduced or eliminated.

In one embodiment of the present invention, the personalization of the visual/audio cue includes the selection of a particular combination from lists of pre-designed visual cues and audio cues. In one embodiment, the user may further modify the pre-designed cues to create a customized (or, “personalized”) version. In one embodiment, the user may draw, paint or capture photo images and/or video clips to create a custom visual cue and record custom audio cue. In one embodiment, the visual cue may include an animated image or a video clip, or a simple textual message.

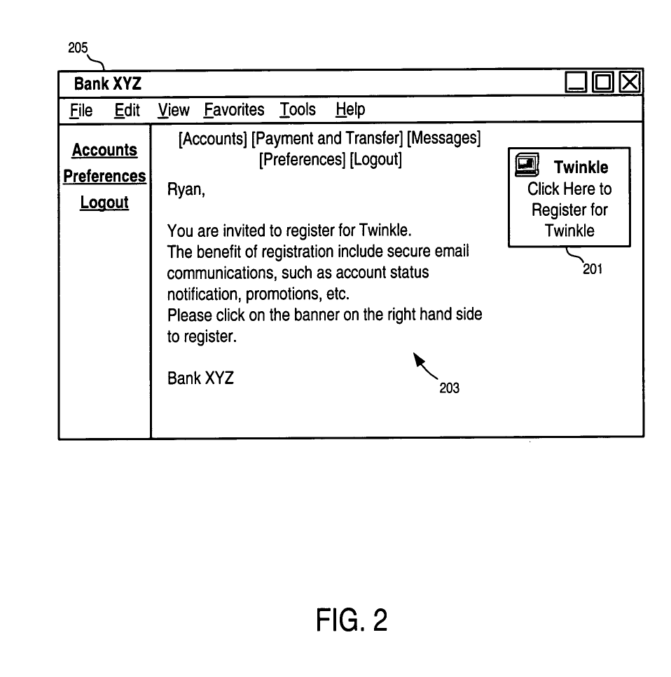

FIG. 2 shows an example of a display of a web page to invite a user to register according to one embodiment of the present invention.

In one embodiment of the present invention, a user is invited to register with a security server (e.g., 109 of FIG. 1) after the identity of the user is confirmed at a web site.

For example, after the user logs into the web site of “Bank XYZ”, the user is presented with a web page (205) that includes a control to detect whether or not the user device has a background security process (e.g., 133) that is typically installed as a result of registering with the security server (e.g., 109).

If the user device does not have the background security process, the web page (205) presents a banner (201) to invite the user to register with the security server. Further, the web page (205) may present information (203) to explain the benefit of registering with the security server. Benefits of registration espoused may include secure email promotions and/or account status notifications, etc.

After the user logs into the web site of the bank, the bank now knows the identity of the person based on the presented login credentials and/or relating the credentials to the internal records of the bank. In one embodiment of the present invention, the bank provides the identity of the person to the security server, in a secure way, to indicate the trustable nature of the user registration.

When the person clicks on the banner, the person is directed to a registration web page (e.g., on a third party site, or a sub-site within the main site). From the new page that is displayed, the person registers their preferences, such as an email address, user id, password, etc.

From the registration web page, the person is prompted to install a client-side application. The client-side application program for the background process is installed and configured on the user device. In one embodiment, the client-side application is installed as a separate application running as a background process as a service. Alternatively, the application may also be installed as a plug-in for a variety of web browsers, email clients, and/or other application programs. Alternatively, the registration process may not require the downloading or installation of a client-side application or plug-in module. For example, the client computer may already have a previously installed application plug-in (e.g. Flash for web browsers) which is programmed to support the operations of one embodiment of the present invention for trust mark display and/or validation. For example, the existent application capabilities, such as Java Script or as-yet-to-be-released scripting capabilities within browsers, can be used to performed the operations of one embodiment of the present invention for trust mark display and/or validation; the scripts/commands utilizing these capabilities can be embedded within, or linked to, the documents (e.g., web pages or emails) that are to be displayed within the application (e.g., web browser).

During the registration with the security server, the client-side application obtains a private key and registers the associated public key with the identity of the person with security server. Thus, the digital signature of the person can be verified using the registered public key.

Alternatively, the user device may install the client-side application for the background process without registering with the security server to obtain limited benefit of sender verification as a recipient.

In one embodiment, the user may indicate that the user trusts the web site. Further, the user may select personalized visual/audio cue for the site.

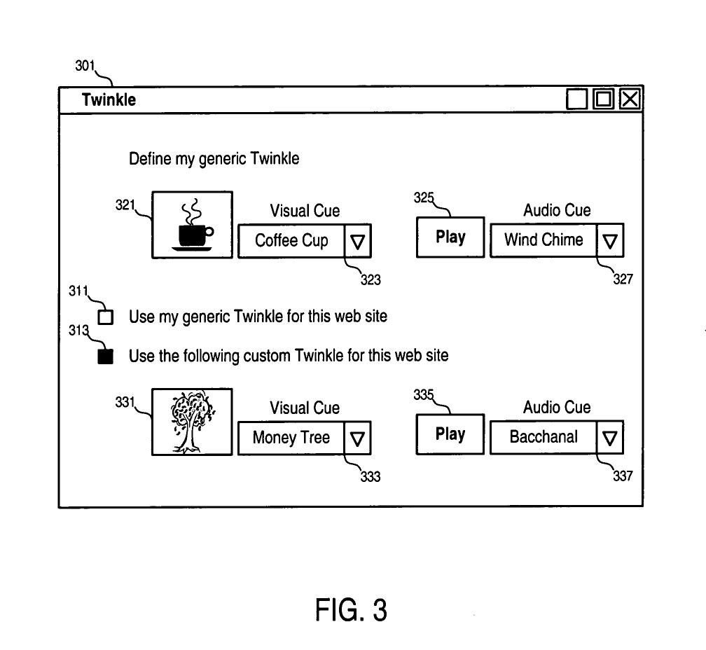

FIG. 3 shows an example of options for a user to personalize visual/audio cue as security feedback according to one embodiment of the present invention.

In FIG. 3, a user interface (301) can be used to specify a generic Twinkle which is applied as default visual/audio cue when the authenticity of a document is verified. For example, the user may use a combobox (323) to select a specific visual cue from a list of visual cues for the generic Twinkle and use a combobox (327) to select a specific audio cue from a list of audio cues for the generic Twinkle. A preview of the visual cue for the generic Twinkle is presented in the area (321); and the button (325) can be activated to play the audio cue for preview.

Similarly, user interface elements (331-337) can be used to select a custom combination of visual/audio cue for a custom Twinkle for the web site.

In one embodiment of the present invention, the user can specify whether to use the generic Twinkle for the specific web site or a custom Twinkle for the specific web site, using the radio buttons (311, 313).

In one embodiment of the present invention, the user can select to play no audio cue and/or no visual cue. In one embodiment of the present invention, the user can import a custom visual cue or a custom audio cue into the application. In one embodiment of the present invention, the visual cue may be a graphical image, an applet, a video clip, an animated image, etc.

During the registration or a configuration session, the user may acknowledge the site from which they were directed as being trusted and select the Twinkle, includes audio and/or visual cue, for the site. In general, the Twinkle may be specific to the site, or may be generic (e.g., the same for default sites that they trust).

From the description of the example of user interface (301), one skilled in the art can envision many alternative user interfaces to specify, personalize the visual/audio cues.

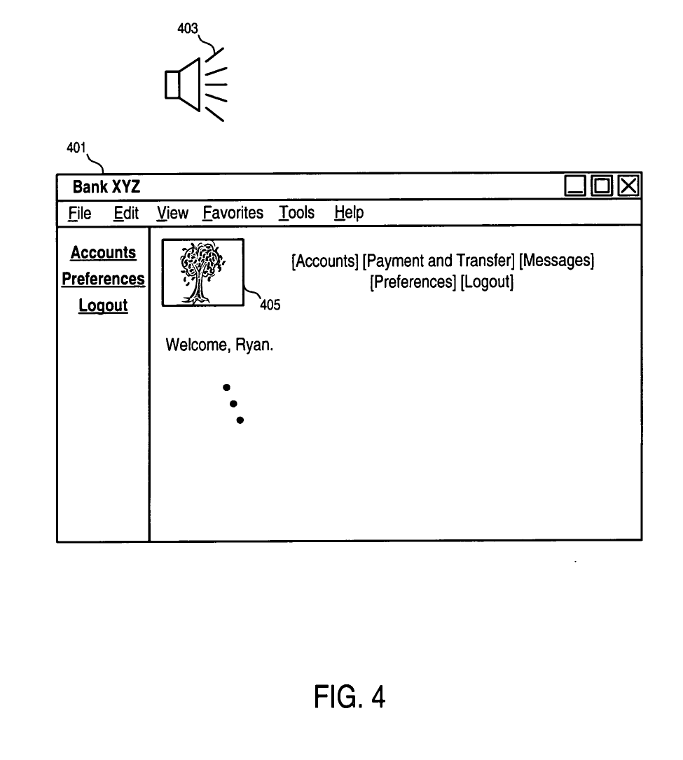

FIG. 4 shows an example of displaying a web page with personalized visual/audio feedback according to one embodiment of the present invention.

In FIG. 4, the web page is verified to be authentic according to the encrypted trust mark data embedded in the web page. According to the user selection, a visual cue (405) is displayed as the trust mark in the web page (401); and an audio cue (403) is played according to the user selection.

In one embodiment, the audio/visual cue is played only when the web page is from a site that has been designated as being trusted by the user, according to the configuration data.

In one embodiment, the audio/visual cue is played according to the configuration data when the security server indicates, or the background security process determines, that the sender is trustworthy.

In one embodiment of the present invention, the user may specify different combinations of visual/audio cue for different levels of trust, such as directly trusted by the user, trusted by the security server, trusted by the web sites (e.g., banks, email servers, etc.) that are trusted by the user, etc.

In one embodiment, when the user arrives at a trusted site, the user is presented with a web page with a control which detects that the user device has already registered for Twinkle and loads encrypted trust mark data into the web page. The encrypted trust mark data includes a digest of site-identifying information signed using the private key of the trusted site. The encrypted trust mark data may include a one-time challenge, negotiated in exchange with the security server.

The background security process then starts the verification that the signed identifying information is associated with a site that the person has previously established a trust bond.

The verification may be performed locally on the user device, or on the security server, or a mix of the user device and the security server.

If verification process determines that the site is trusted, the client-side control plays the person's Twinkle to indicate that the page/site can be trusted.

In one embodiment, the Twinkle is played when the cursor of the user device is positioned over an icon or link of the document (e.g., for a period of time).

If the site is not trusted (for any reason), the client-side control remains silent, or plays an anti-secure audio/visual cue based on the person's preferences.

In one embodiment of the present invention, the user can click on the trust mark to activate a user interface to configure the security parameters, such as the designation of trusted sites, the selections of visual/audio cues for Twinkles, etc.

In one embodiment of the present invention, a trust mark includes encrypted data which when verified can caused the display of visual/audio cue in a web page or in an email message. In one embodiment of the present invention, a trust mark can be displayed in various formats to make it easy for a user to identify and use the trust mark. In one embodiment of the present invention, the verification process is started when the cursor hovers over the representation of the trust mark.

In one embodiment of the present invention, a background application process detects when a user places their mouse over a representation of trust mark (e.g., an icon or a hyper link). The background application verifies the validity of the encrypted data of the trust mark in response to the mouse over event on the trust mark.

In one embodiment, the encrypted data of the trust mark is sent to a validation service (e.g., a web serve that verifies the encrypted data has the information required to validate the trust mark.)

In one embodiment, the data in the trust mark is encrypted using the private key of the sender and the public key of the receiver. This ensures that the trust mark can be used to determine if the origin and destination of the email message is as stated is true.

Although FIG. 4 illustrates a web page with a trust mark according to one embodiment of the present invention in an authenticated context (e.g., after the user logs into the personal bank web page), the web pages with trust marks according to embodiments of the present invention can also be used in an un-authenticated context.

In one embodiment of the present invention, when the sender is aware of the identity of the recipient (e.g., after the user logs into the personal bank web page, or the email is prepared for the recipient), the trust mark is prepared in a recipient-dependent way. For example, the trust mark data is superencrypted with the public key of the recipient so that the validation of the trust mark involves the use of the private key of the recipient.

In one embodiment of the present invention, when the sender is not aware of the identity of the recipient (e.g., when presenting the login page to receive the online banking credentials from the user), the trust mark is generated in a recipient-independent way. In one embodiment of the present invention, the trust mark data is superencrypted with the public key of the security server (e.g., 109); and the background security process on the user device can communicate with the security server for the validation of the trust mark.

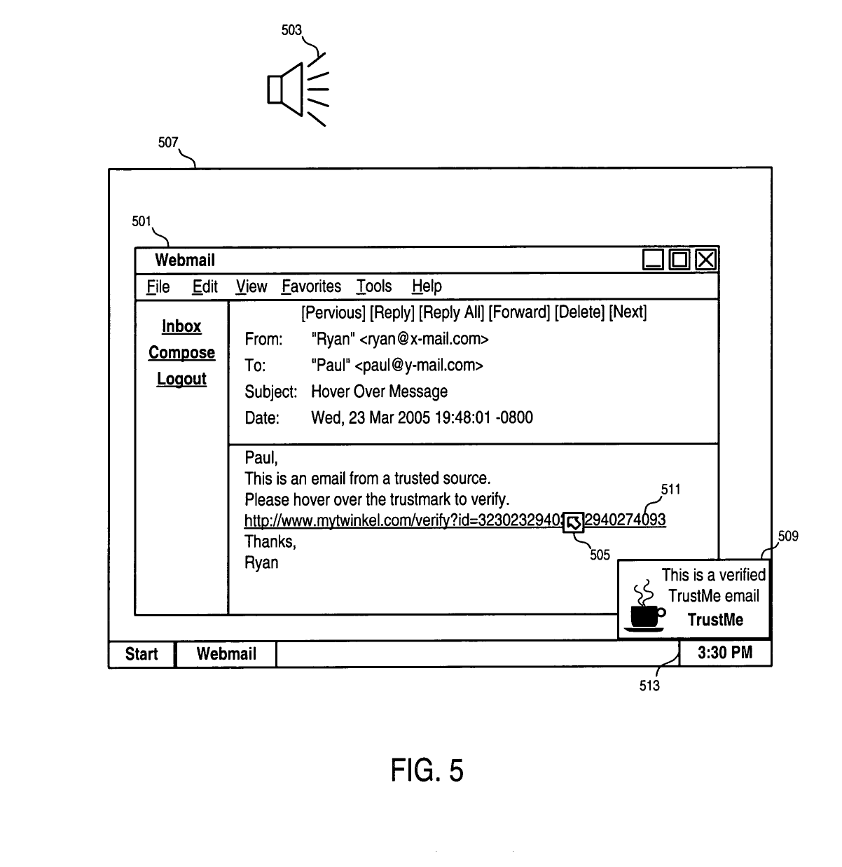

FIG. 5 shows another example of displaying a web page with personalized visual/audio feedback according to one embodiment of the present invention.

The user is a registered with a security server. The background security process detects whether the cursor (505) is positioned over the trust mark (511). In one embodiment, the trust mark (511) in the document is presented as a text link. Alternatively, a graphical link (e.g., an icon) or other types of graphical user elements can be used.

In one scenario, the user opens the email message in a browser window (501) and sees a verification code (511) at the bottom of the email message. The user positions the cursor (e.g., under the control of a mouse, track ball, or touch pad) over the verification code.

When the background security process detects that the cursor (505) is hovering over the trust mark (511), the background security process grabs the encrypted data from the trust mark (511) to verify whether the encrypted data is valid. If the code is valid, the background security process notifies an application software to display the Twinkle Icon (509) and play the Twinkle Tune (503), according to the user selection (e.g., in FIG. 3) so the user knows that the email is actually sent for the source as claimed and it was actually destined for the user.

In one embodiment of the present invention, the Twinkle Icon (509) is displayed near the icon tray (513) of the graphical user interface desktop (507).

In one embodiment of the present invention, when the mouse hovers over the trust mark (405) in FIG. 4, a popup window similar to the window (509) in FIG. 5 is also displayed when the trust mark is validated.

In one embodiment of the present invention, the trust mark is initially presented in a first graphical representation (e.g., generic) as specified by the sender. When the mouse hovers over the trust mark, the validation process starts. After the trust mark is validated, personalized visual and audio cues are presented. In one embodiment, after the successful validation of the trust mark, the first graphical representation of the trust mark is replaced with a second graphical representation which is personalized by the user (e.g., a user selected Twinkle icon, or a user imported custom icon).

Alternatively, the validation may be started automatically when the document is loaded into the browser, or when the background process detects the presence of the trust mark in the document, or when the user clicks on the trust mark. For example, when a selection (e.g., by clicking with a mouse, a touch pad, a touch screen, or other cursor control and selection device) of a graphical user interface element of a browser window, or a graphical user interface element embedded in the document (e.g., email, or web page, that has a trust mark according to embodiments of the present invention), the validation of the trust mark starts. Alternatively, when the application program process presents the document (e.g., web page or email) with an embedded trust mark that has encrypted data, the application program process is programmed (e.g., through a plug-in module) to automatically detect the trust mark (e.g., as an embedded graphical user interface element, or other type of binary or textual element) and start the trust mark verification according to embodiments of the present invention.

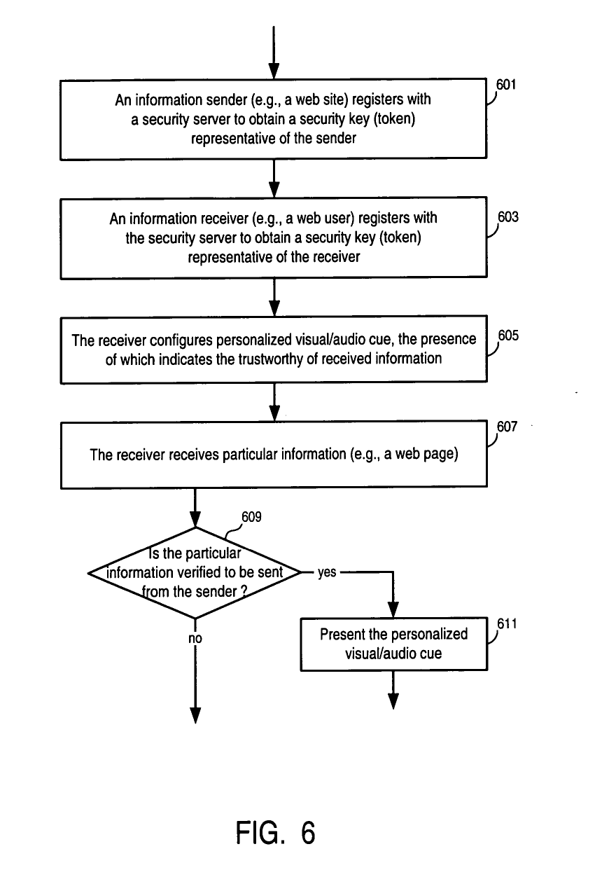

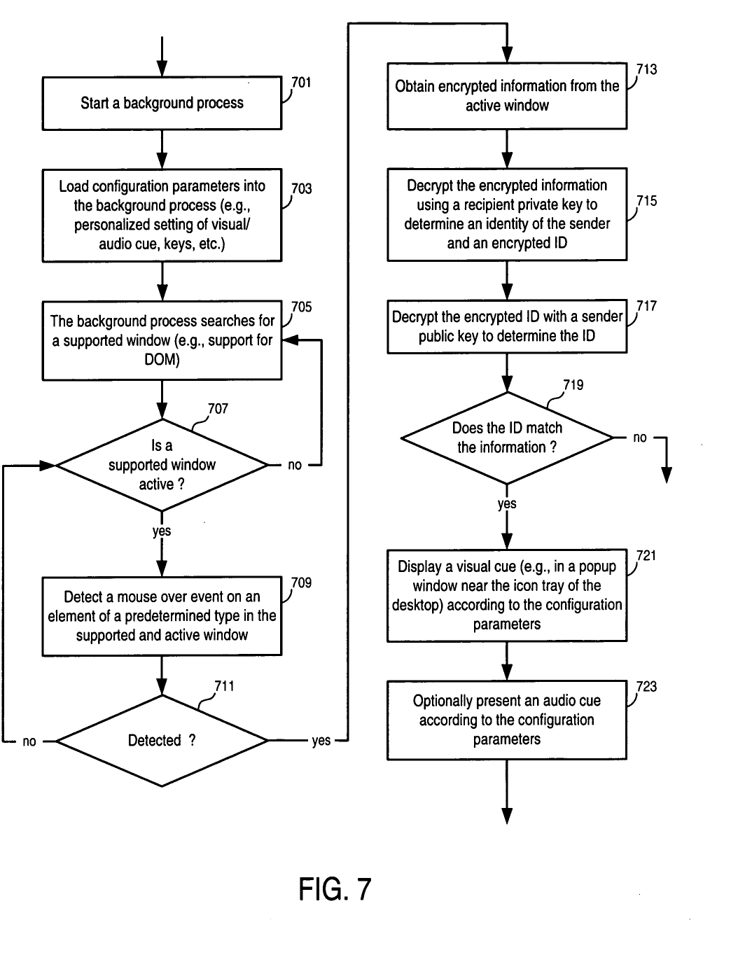

FIGS. 6 and 7 show flow diagrams of methods to provide personalized visual/audio feedback according to embodiments of the present invention.

In operation 601, an information sender (e.g., a web site) registers with a security server to obtain a security key (token) representative of the sender. In operation 603, an information receiver (e.g., a web user) registers with the security server to obtain a security key (token) representative of the receiver. In operation 605, the receiver configures personalized visual/audio cue, the presence of which indicates the trustworthy of received information.

In operation 607, the receiver receives particular information (e.g., a web page). If operation 609 determines that the particular information is verified to be sent from the sender, operation 611 presents the personalized visual/audio cue.

In one embodiment, the personalized visual/audio cue is presented after it is validated that the user previously designated the sender as a trusted entity. In one embodiment, a different personalized visual/audio cue is presented after it is determined that the sender is not previously designated by the user as a trusted entity

In FIG. 7, operation 701 starts a background process. Operation 703 loads configuration parameters into the background process (e.g., personalized setting of visual/audio cue, keys, etc.). In one embodiment, the configuration parameters include the private key of the user and the user selection of a particular icon/tune combination for particular senders/websites.

The background process searches for a supported window (e.g., support for DOM) in operation 705, until operation 707 determines that there is an active, supported window.

Operation 709 detects a mouse over event on an element of a predetermined type in the supported and active window. If operation 711 determines the mouse over event is detected, operation 713 obtains encrypted information from the active window.

In one embodiment, the trust mark is loaded in the web browser. The web browser process and the background security process are running separately from each other. The content of the trust mark is communicated from the browser process to the background process after the detection of the mouse over event.

In one embodiment of the present invention, when the mouse enters the graphical area of a trust mark or when the mouse moves over a recognizable hyper link, Windows System Messages are generated. By analyzing the Windows System Messages, the background security process can determine that the mouse is over a supported trust mark.

There are a variety of ways the background process can grab the encrypted data of the trust mark from the browser process. For example, the data can be extracted from Internet Explorer or Firefox using the exposed DOM, or from Outlook through communicating with an Outlook plug-in.

Operation 715 decrypts the encrypted information using a recipient private key to determine an identity of the sender and an encrypted ID. Operation 717 decrypts the encrypted ID with a sender public key to determine the ID. In one embodiment the ID includes an original version of the digest of the information loaded in the active, supported window (e.g., the digest generated at the sender of the information).

If operation 719 determines that the ID match the information, operation 721 displays a visual cue (e.g., in a popup window near the icon tray of the desktop) according to the configuration parameters. Optionally, operation 723 presents an audio cue according to the configuration parameters.

Alternatively, the web page can be changed to show the Twinkle icon inside the document or play an applet to show the Twinkle icon.

In one embodiment, the background security process sends sender's identity, the current digest of the information and the digital signature (decrypted with the private key of the receiver) to a web server for verification.

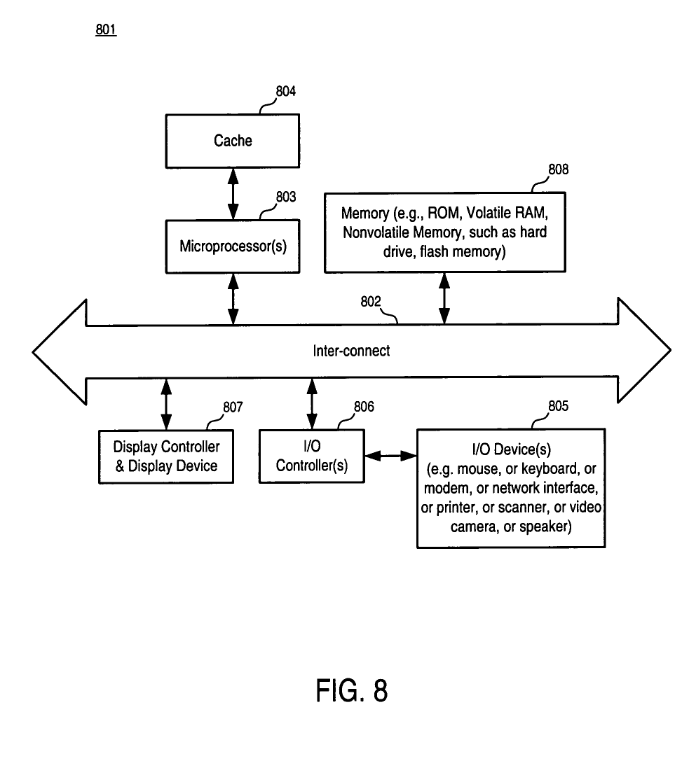

FIG. 8 shows a block diagram example of a data processing system which may be used with the present invention. Note that while FIG. 8 illustrates various components of a computer system, it is not intended to represent any particular architecture or manner of interconnecting the components. It will also be appreciated that network computers and other data processing systems, such as a handhold computer, a personal digital assistance, or a cellular phone, which have fewer or more components, may also be used with the present invention.

In FIG. 8, the communication device (801) is a form of a data processing system. The system (801) includes an inter-connect (802) (e.g., bus and system core logic), which interconnects a microprocessor(s) (803) and memory (808). The microprocessor (803) is coupled to cache memory (804) in the example of FIG. 8.

The inter-connect (802) interconnects the microprocess(s) (803) and the memory (808) together and also interconnects them to a display controller and display device (807) and to peripheral devices such as input/output (I/O) devices (805) through an input/output controller(s) (806). Typical I/O devices include mice, keyboards, modems, network interfaces, printers, scanners, video cameras, speakers and other devices which are well known in the art.

The inter-connect (802) may include one or more buses connected to one another through various bridges, controllers and/or adapters. In one embodiment the I/O controller (806) includes a USB (Universal Serial Bus) adapter for controlling USB peripherals, and/or an IEEE-1394 bus adapter for controlling IEEE-1394 peripherals.

The memory (808) may include ROM (Read Only Memory), and volatile RAM (Random Access Memory) and non-volatile memory, such as hard drive, flash memory, etc.

Volatile RAM is typically implemented as dynamic RAM (DRAM) which requires power continually in order to refresh or maintain the data in the memory. Non-volatile memory is typically a magnetic hard drive, a magnetic optical drive, or an optical drive (e.g., a DVD RAM), or other type of memory system which maintains data even after power is removed from the system. The non-volatile memory may also be a random access memory.

The non-volatile memory can be a local device coupled directly to the rest of the components in the data processing system. A non-volatile memory that is remote from the system, such as a network storage device coupled to the data processing system through a network interface such as a modem or Ethernet interface, can also be used.

In one embodiment of the present invention, a server data processing system as illustrated in FIG. 8 is used as the security server (e.g., 109 in FIG. 1). In one embodiment of the present invention, a data processing system as illustrated in FIG. 8 is used as a user device (e.g., 119 in FIG. 1), which may include more or less components. A data processing system as the user device can be in the form of a PDA, a cellular phone, a notebook computer, a personal desktop computer, etc.

In general, the routines executed to implement the embodiments of the invention may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations necessary to execute elements involving the various aspects of the invention.

While some embodiments of the invention have been described in the context of fully functioning computers and computer systems, those skilled in the art will appreciate that various embodiments of the invention are capable of being distributed as a program product in a variety of forms and are capable of being applied regardless of the particular type of machine or computer-readable media used to actually effect the distribution.

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks, (DVDs), etc.), among others, and transmission type media such as digital and analog communication links for electrical, optical, acoustical or other forms of propagated signals, such as carrier waves, infrared signals, digital signals, etc.

A machine readable medium can be used to store software and data which when executed by a data processing system causes the system to perform various methods of the present invention. The executable software and data may be stored in various places including for example ROM, volatile RAM, non-volatile memory and/or cache. Portions of this software and/or data may be stored in any one of these storage devices.

In general, a machine readable medium includes any mechanism that provides (i.e., stores and/or transmits) information in a form accessible by a machine (e.g., a computer, network device, personal digital assistant, manufacturing tool, any device with a set of one or more processors, etc.).

Aspects of the present invention may be embodied, at least in part, in software. That is, the techniques may be carried out in a computer system or other data processing system in response to its processor, such as a microprocessor, executing sequences of instructions contained in a memory, such as ROM, volatile RAM, non-volatile memory, cache or a remote storage device.

In various embodiments, hardwired circuitry may be used in combination with software instructions to implement the present invention. Thus, the techniques are not limited to any specific combination of hardware circuitry and software nor to any particular source for the instructions executed by the data processing system.

In this description, various functions and operations are described as being performed by or caused by software code to simplify description. However, those skilled in the art will recognize what is meant by such expressions is that the functions result from execution of the code by a processor, such as a microprocessor.

Although some of the drawings illustrate a number of operations in a particular order, operations which are not order dependent may be reordered and other operations may be combined or broken out. While some reordering or other groupings are specifically mentioned, others will be apparent to those of ordinary skill in the art and so do not present an exhaustive list of alternatives. Moreover, it should be recognized that the stages could be implemented in hardware, firmware, software or any combination thereof.

In the foregoing specification, the invention has been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. A machine readable medium containing executable computer program instructions which when executed by a data processing system cause said system to perform a method for authentication, the method comprising:
determining an indication of a cursor being positioned over a graphical user interface element of a first application process for a period of time, the first application process to present information, the graphical user interface element having encrypted data obtained with the information;
in response to the indication:
obtaining the encrypted data from the graphical user interface element; and
determining whether or not the information is trusted using the encrypted data.

2. The medium of claim 1, wherein the information comprises one of:
a web page; and
an email message.

3. The medium of claim 2, wherein the first application process comprises a web browser; and the graphical user interface element comprises one of:
a graphical representation of a trust mark; and
a hyper link.

4. The medium of claim 1, wherein said determining whether or not the information is trusted comprises:
verifying an identity of a sender of the information; and
verifying integrity of the information.

5. The medium of claim 4, wherein said determining whether or not the information is trusted further comprises:
verifying an identity of a recipient of the information.

6. The medium of claim 5, wherein:
said verifying the identity of the recipient comprises decrypting the encrypted data using a private key of the recipient;
said verifying the identity of the sender comprises decrypting a version of the encrypted data using a public key of the sender; and
said verifying the integrity of the information comprises comparing a decrypted version of the encrypted data with a processed version of the information.

7. The medium of claim 6, wherein the processed version of the information comprises a digest of the information.

8. The medium of claim 1, wherein the method further comprises one of:
presenting a personalized visual cue when the information is determined to be trusted; and
presenting a personalized audio cue when the information is determined to be trusted.

9. The medium of claim 8, wherein the indication is determined through analyzing windows system messages.

10. The medium of claim 8, wherein the visual cue and the audio cue are presented in a second process which is separate from the first application process.

11. The medium of claim 10, wherein the second process is a background service process.

12. The medium of claim 10, wherein the encrypted data is obtained from the graphical user interface element through a document object model (DOM).

13. The medium of claim 10, wherein the second process presents the visual cue in a popup window near an icon tray of a desktop of a graphical user interface system.

14. The medium of claim 10, wherein at least one of the visual cue and the audio cue is specifically personalized for at least one of:
a user of the first application process; and
a sender of information.

15. The medium of claim 10, wherein at least one of the visual cue and the audio cue is selected from one or more lists for a user of the first application process.

16. The medium of claim 10, wherein at least one of the visual cue and the audio cue is imported from user provided data.

17. The medium of claim 1, wherein the encrypted data comprises a superencrypted version of a digital signature of a sender of the information on the information; wherein the digital signature is superencrypted with a public key of a recipient of the information.

18. A machine readable medium containing executable computer program instructions which when executed by a data processing system cause said system to perform a method for authentication, the method comprising:
determining whether or not information loaded into a first application for display to a first user is trusted based on encrypted data obtained with the information; and
in response to a determination that the information is trusted, presenting a user designated visual cue to indicate that the information is trusted.

19. The medium of claim 18, wherein the visual cue is presented as part of the information in the first application.

20. The medium of claim 19, wherein the first application comprises a web browser.

21. The medium of claim 18, wherein the method further comprises:
in response to the determination that the information is trusted, presenting a user designated audio cue to indicate that the information is trusted.

22. The medium of claim 21, wherein at least one of the visual cue and the audio cue is selected by the first user from one or more lists.

23. The medium of claim 22, wherein said determining whether or not the information is trusted comprises:
verifying an identity of a sender of the information.

24. The medium of claim 23, wherein at least one of the visual cue and the audio cue is user selected specifically for the sender.

25. The medium of claim 21, wherein at least one of the visual cue and the audio cue is customized by the first user.

26. The medium of claim 18, wherein the method further comprises:
detecting presence of the encrypted data in the information loaded into the first application process in a second process through a document object model (DOM).

27. The medium of claim 26, wherein the method further comprises:
detecting an event of a cursor over a representation of the encrypted data in the first application through analyzing windows system messages in the second process.

28. A method for authentication, the method comprising:
determining an indication of a cursor being positioned over a graphical user interface element of a first application process for a period of time, the first application process to present information, the graphical user interface element having encrypted data obtained with the information;
in response to the indication:
obtaining the encrypted data from the graphical user interface element; and
determining whether or not the information is trusted using the encrypted data.

29. The method of claim 28, wherein the information comprises one of:
a web page; and
an email message; and
wherein the first application process comprises a web browser; and
wherein the graphical user interface element comprises one of:
a graphical representation of a trust mark; and
a hyper link.

30. The method of claim 28, wherein said determining whether or not the information is trusted comprises:
verifying an identity of a sender of the information; and
verifying integrity of the information.

31. The method of claim 28, further comprising one of:
presenting a personalized visual cue when the information is determined to be trusted; and
presenting a personalized audio cue when the information is determined to be trusted.
wherein the indication is determined through analyzing windows system messages;
wherein the visual cue and the audio cue are presented in a second process which is separate from the first application process; and
wherein the encrypted data is obtained from the graphical user interface element through a document object model (DOM).

32. The method of claim 31, wherein at least one of the visual cue and the audio cue is specifically personalized for at least one of:
a user of the first application process; and
a sender of information.

33. A method for authentication, the method comprising:
determining whether or not information loaded into a first application for display to a first user is trusted based on encrypted data obtained with the information; and
in response to a determination that the information is trusted, presenting at least one of a user designated visual cue and a user designated audio cue to indicate that the information is trusted.

34. The method of claim 33, wherein at least one of the visual cue and the audio cue is selected by the first user from one or more lists or customized by the first user.

35. The method of claim 34, wherein said determining whether or not the information is trusted comprises:
verifying an identity of a sender of the information;
wherein at least one of the visual cue and the audio cue is user selected specifically for the sender.

36. The method of claim 33, further comprising:
detecting presence of the encrypted data in the information loaded into the first application process in a second process through a document object model (DOM); and
detecting an event of a cursor over a representation of the encrypted data in the first application through analyzing windows system messages in the second process.

37. A data processing system for authentication, the system comprising:
means for determining an indication of a cursor being positioned over a graphical user interface element of a first application process for a period of time, the first application process to present information, the graphical user interface element having encrypted data obtained with the information;
means for, in response to the indication, obtaining the encrypted data from the graphical user interface element; and
means for, in response to the indication, determining whether or not the information is trusted using the encrypted data.

38. The system of claim 37, wherein the information comprises one of:
a web page; and
an email message; and
wherein the first application process comprises a web browser; and
wherein the graphical user interface element comprises one of:
a graphical representation of a trust mark; and
a hyper link.

39. The system of claim 37, wherein said means for determining whether or not the information is trusted comprises:
means for verifying an identity of a sender of the information; and
means for verifying integrity of the information.

40. The system of claim 37, further comprising one of:
means for presenting a personalized visual cue when the information is determined to be trusted; and
means for presenting a personalized audio cue when the information is determined to be trusted.
wherein the indication is determined through analyzing windows system messages;
wherein the visual cue and the audio cue are presented in a second process which is separate from the first application process; and
wherein the encrypted data is obtained from the graphical user interface element through a document object model (DOM).

41. The system of claim 40, wherein at least one of the visual cue and the audio cue is specifically personalized for at least one of:
a user of the first application process; and
a sender of information.

42. A data processing system for authentication, the system comprising:
means for determining whether or not information loaded into a first application for display to a first user is trusted based on encrypted data obtained with the information; and
means for, in response to a determination that the information is trusted, presenting a user designated visual cue to indicate that the information is trusted.

43. The system of claim 42, further comprising:
means for, in response to the determination that the information is trusted, presenting a user designated audio cue to indicate that the information is trusted;
wherein at least one of the visual cue and the audio cue is selected by the first user from one or more lists or customized by the first user.

44. The system of claim 43, wherein said means for determining whether or not the information is trusted comprises:
means for verifying an identity of a sender of the information;
wherein at least one of the visual cue and the audio cue is user selected specifically for the sender.

45. The system of claim 42, further comprising:
means for detecting presence of the encrypted data in the information loaded into the first application process in a second process through a document object model (DOM); and
means for detecting an event of a cursor over a representation of the encrypted data in the first application through analyzing windows system messages in the second process.
